(19) United States
(12) Patent Application Publication
(10) Pub. No.: US 2011/0022835 A1
(43) Pub. Date: Jan. 27, 2011

(54) Secure Communication Using Asymmetric Cryptography and Light-Weight Certificates

(75) Inventor: Norman Schibuk, Merrick, NY (US)

Correspondence Address: Sunstein Kann Murphy & Timbers LLP, 125 SUMMER STREET, BOSTON, MA, 02110-1618, US

(73) Assignee: SurIDx, Inc., Wellesley, MA (US)

(21) Appl. No.: 12/844,355

(22) Filed: Jul. 27, 2010

Related U.S. Application Data
(60) Provisional application No. 61/228,847, filed on Jul. 27, 2009.

(51) Int. Cl. H04L 9/00; H04L 29/06; G06Q 20/00

(52) U.S. Cl. 713/153; 713/156; 713/159; 705/64

(57) ABSTRACT

Encrypted communications between servers and client devices over an unsecured channel, such as the Internet, without using a public key infrastructure are disclosed. Messages to a client device are encrypted using an encryption key of an authorized individual, regardless of the identity of the user of the client device. Encryption is performed by a system that does not expose encryption keys to the client device or the server, thereby preventing man-in-the-middle attacks against the encryption key. Secure communications are combined with a two-factor protocol for authenticating the identity of an individual. An individual authenticates by generating a cipher using a light-weight certificate that has a shared secret but no other information identifying the individual. Separately, a server generates the same cipher using the shared secret, thereby authenticating the individual's identity to a relying party.

### CROSS-REFERENCE TO RELATED APPLICATIONS

This application claims the benefit of U.S. Provisional Application No. 61/228,847, filed Jul. 27, 2009, which is incorporated by reference in its entirety herein.

### TECHNICAL FIELD

The present invention relates to facilitating secure, two-way communication between a client and a server using unsecured communication channels, and more particularly to encrypting outbound and inbound communications based on encryption keys stored in a secure database inaccessible to the server.

### BACKGROUND ART

It is known in the prior art to encrypt communications between a client computing device and a server computing device using public key encryption. Typically, a client wishing to establish secure communications with a server will transmit a message to the server. The two devices will then follow a protocol to determine an encryption algorithm that both devices implement, and determine a shared secret that may be used to encrypt messages between the two devices. Two such protocols are the Secure Sockets Layer, and its successor, Transport Layer Security. Once the protocol has been completed, the devices begin encrypted communications using the negotiated encryption algorithm. It is also known to encrypt communications using symmetric encryption, whereby a single, shared secret is combined with data to be protected to form an encrypted message, and the same shared secret is combined with the encrypted message in an inverse process to recover the original data.

These approaches permit encrypted communications between a server and an arbitrary client. However, an attacker may wish to gain unauthorized access to the server, or otherwise cause damage. Such an attacker may enter the communications protocol, and engage in encrypted but unauthorized communications with a server. Various gateway systems, such as firewalls, have been employed between clients and servers to protect servers. A firewall protects a server by analyzing incoming client communications, and permitting only authorized clients to communicate with servers. Because a firewall cannot control which communications it receives, robust rules for analyzing and filtering inbound traffic tend to be complicated, and their administration requires considerable time, skill, and expense.

Public keys for use in public key encryption may be distributed using public key infrastructures (PKI). Public key infrastructures create, manage, distribute, and revoke digital certificates. These digital certificates often contain a public key for use, in conjunction with a private key, in an asymmetric encryption system such as PKCS#1 encryption, ElGamal encryption, and elliptic curve encryption. Public key infrastructures require, among other things, publication of a public key. An individual having a matched private key may receive secure communications from a third party. The third party first obtains a digital certificate containing the individual's public key, from whatever source. The third party then validates the certificate, which may have been revoked. Using the public key contained therein, the third party encrypts a message for the individual, and transmits it. The individual then uses the matching private key to decrypt the message.

A major obstacle to the use of such systems is that of validating the public key certificates. Typically, the validity of a certificate must be checked before its information can be used to authenticate an individual. Such checking may be performed by consulting a certificate revocation list (CRL) or by performing a status protocol such as the Online Certificate Status Protocol (OCSP). A claimed advantage to using this prior art scheme is that it may be performed without contacting the issuing server, saving processing power on the server.

However, in practice, many administrative authorities wish to issue many public key certificates, and each authority must distribute a CRL or participate in a status protocol. Each party that wishes to rely on data in a certificate requires a copy of each CRL in the system, and this copy must be refreshed each time the CRL is updated with a new revocation. Thus, the process of validating certificates does not scale linearly with the number of certificates, slowing the adoption of PKI systems.

RSA Security, a division of EMC Corporation of Bedford, Mass., has developed a system of pseudo random number generation that is based on time. RSA distributes security tokens such as the RSA SecurIDO that display a sequence of numbers that changes as time progresses. This sequence of numbers may be reconstructed by RSA using the current time and a token serial number. When an individual possessing a token wishes to authenticate, the individual provides the number that appears on the device and a matching time based computation is done on the authentication side. This system provides a high level of security, but requires distribution of security tokens and a specialized server at the authentication site.

The systems and methods presented herein for revoking digital certificates avoid the need for processing of revocation certificates taught in my prior U.S. patent application Ser. No. 12/267,065, filed Nov. 7, 2008 (the '065 application); this related application is hereby incorporated herein by reference in its entirety.

### SUMMARY OF ILLUSTRATED EMBODIMENTS OF THE INVENTION

Illustrated embodiments of the invention provide secure, encrypted communications between servers and authorized clients over an unsecured data communications channel, without requiring a traditional PKI. A secure communications channel is established by encrypting outbound server messages using a locally-stored encryption key of the purported client, rather than retrieving this key from a PKI as would be done in the prior art. Thus, man-in-the-middle attacks on the (usually insecure) data path between the PKI and the server are entirely eliminated. Also, because the encryption keys are locally stored, they may “revoked” by simply deleting them from the local storage. Thus, various embodiments of the invention also eliminate the need to distribute CRLs to large numbers of clients, or to respond to OCSP requests. Further, worldwide revocation of the use of particular encryption keys may be effected nearly instantaneously.

Outbound communications from a server, unlike inbound communications to the server, are entirely within the control of the administrative entity that provides the server. The administrative entity may thus control outbound communications much more easily, saving it considerable time, skill, and expense. Thus, in accordance with various embodiments of the present invention, in addition to any encryption that may be present between the client and the server (such as a TLS connection), all data transmitted from the secure system is further encrypted using an encryption key of the recipient that is accessible only from a gateway interposed between the server and the client on the server-to-client (outbound) data path. The client may then decrypt the further-encrypted data by using a securely-stored decryption key.

In various embodiments, all data transmitted from the secure system are encrypted by an encryption key of the recipient, for example a symmetric key for use in symmetric cryptography, or a public key created (but not distributed) using methods known in the art as part of a public-private key asymmetric encryption pair. In one embodiment, the corresponding decryption key is loaded out-of-band on a separate encryption device inaccessible to the server. If an attacker is able to create an inbound communication that bypasses a secure gateway in which an embodiment of the present invention is operating, the attacker must still decrypt the data using the decryption key of the recipient, which the attacker does not have. All data messages from the server may be encrypted by a separate process inaccessible to the server. In addition, forging a login using a stolen decryption key may be made more difficult, by associating a biometric or other identity challenge before granting the decryption key to a would-be system cracker.

Also in various embodiments, further securing the system, a random sampling of access attempts may be sent, not just to the client requesting access, but to a second, unrelated system for independent verification.

In a first illustrative embodiment there is provided a system for facilitating secure data communication from a server to a client device of an individual using a data communications channel. The system includes a database, a processor, and a communications gateway. The database stores a plurality of encryption keys in a storage arrangement, where at least one stored encryption key is uniquely and privately associated with the individual. The processor is in data communication with the database, and is configured to receive a message, created by the server in response to a request by a client device purporting to be that of the individual. The processor is also configured to retrieve from the database the encryption key that is uniquely and privately associated with the individual. The processor is further configured to encrypt the message using the retrieved encryption key to form an encrypted message that only the client device of the individual is capable of decrypting. Thus, if the client device making the request is not the client device of the individual, it will be unable to decrypt the encrypted message. The communications gateway is in data communication with the data communications channel, the processor, and the server. It is configured to transmit, to the server, messages that are received from the data communications channel for delivery to the server. The gateway is also configured to transmit, to the processor, the message created by the server in response to the request by the client device purporting to be that of the individual. Finally, the gateway is configured to transmit the encrypted message to the data communications channel for delivery to the client device purporting to be that of the individual.

In some cases, the client device purporting to be that of the individual is the client device of the individual, and is therefore capable of decrypting the encrypted message. In other cases, the client device purporting to be that of the individual is not the client device of the individual, and is therefore incapable of decrypting the encrypted message. In some useful embodiments, the encryption key is exposed only to the processor. Thus, even if the server is compromised and an attacker sends a message to the compromised server from his own device, the attacker's device will not be able to alter any encryption keys stored in the database. These embodiments provide an advantage over the prior art, as communications are secure even if both ends of the communications channel are compromised.

In a related illustrated embodiment there is provided a method of facilitating secure data communication from a server to a client of an individual over a data communications channel. The method includes receiving a message, created by the server in response to a request by a client device purporting to be that of the individual. The method further includes encrypting the message to form an encrypted message that only the client device of the individual is capable of decrypting. Encrypting provides to the contents of the response message a layer of encryption in addition to any layer of encryption present in the request by the client device purporting to be that of the individual. The method also includes transmitting the encrypted message to the data communications channel for delivery to the client device purporting to be that of the individual.

As with the system embodiment, in some cases the client device purporting to be that of the individual is the client device of the individual, and is therefore capable of decrypting the encrypted message. In other cases, the client device purporting to be that of the individual is not the client device of the individual, and is therefore incapable of decrypting the encrypted message. Also, encrypting the contents of the response message may include retrieving the encryption key from a database of encryption keys, wherein the encryption key is not exposed to the server or to the client device purporting to be that of the individual.

In another illustrative embodiment, the invention provides a communications gateway for facilitating secure data communication between a client and a server over a data communications channel. The gateway includes a first data path for forwarding a client request message from the client to the server and a second data path having an input for receiving a response message from the server, responsive to the client request message. It also includes a processor, coupled to the second data path, for encrypting the contents of the response message using an encryption key to form an encrypted message, the public key being uniquely associated with a decryption key stored for use by the client, so as to provide to the contents of the response message a layer of encryption in addition to any layer of encryption present in the client request message. The second data path includes an output for transmitting the encrypted message to the client over the data communications channel. In a further related embodiment, the gateway also has a storage system, coupled to the processor, containing an encryption key database, such storage system inaccessible to the server. In a further related embodiment, the storage system and the server are coupled to an administrative control system for exercise of common control over the public key database and the server.

Embodiments of the present invention may be used advantageously in situations in which an individual desires to be authenticated to a relying party. A server creates a shared secret, and places that shared secret in a light-weight certificate (LWC), defined below. The server provides the LWC to a token facility of the individual, such as a smartcard. The LWC is typically not shared with any other parties, such as a public certificate server, as would be done in the prior art. However, in some embodiments the client device transmits the LWC to a trusted third party token facility (or the server transmits the shared secret to the trusted third party directly). The trusted third party may use the LWC in its own token facility, such as a virtual smartcard, in accordance with methods disclosed in U.S. patent application Ser. No. 12/267,065. Also, in some embodiments the server stores the shared secret in a secure storage network, so that other trusted servers may access the shared secret. Thus, the relationship between the LWC and the individual is not known to the general public (and in particular, to any would-be attackers).

This arrangement permits an individual to be authenticated to another, relying party without requiring the relying party to validate a certificate using a certificate revocation list (CRL) or by participating in a certificate status protocol. In accordance with various embodiments of this invention, an individual's light-weight certificate cannot be used as a standalone assertion of a specific identity by the individual—the issuing server must perform one part of a two-party handshake to authenticate the individual. In some embodiments, identification is performed by the issuing server (or by a network of servers) using the shared secret, at the request of the individual. Such embodiments may be used (for example) in a commercial setting, to request approval for a credit transaction. These embodiments advantageously only require a single request-response pair to complete a secure transaction.

In other embodiments, identification is performed by the client device, after it transmits a request for authentication to the server and receives an affirmative response. Such embodiments may be used (for example) to ‘unlock’ a certificate for use in an area having limited network connectivity. These embodiments use a first request-response pair to unlock the certificate using a data network, and a further, local request-response pair that does not require accessing the network to complete further transactions.

Because no CRL updates are required, certificate revocation becomes a process that scales linearly with the number of certificates in the system. Furthermore, this arrangement distributes the work of processing certificate validation requests, and avoids the need to use third-party certificate authorities. Nevertheless, to the extent that a third party wishes to use a certificate for purposes other than identifying the individual, and to the extent that the individual does not object to publication of his or her certificate, the light-weight certificates herein described can be used with existing public key infrastructures. Thus, the systems and methods disclosed herein represent an improvement over those disclosed in U.S. patent application Ser. No. 12/267,065.

In an exemplary embodiment of the invention there is provided a method of efficiently managing a certificate life cycle in the course of authentication of an individual by an authentication service. The method includes, in a first computer process, creating a secret number. In a second computer process, the method includes creating a light-weight certificate, privately associating the light-weight certificate with the individual, and storing such private association in a non-volatile storage arrangement. The certificate itself contains the secret number, but lacks data associating the certificate with the individual. The method further includes transmitting the light-weight certificate to the individual, so that only the individual and the authentication service possess the secret number. Transmission may be accomplished through any appropriate means, and does not require a computer. For example, the certificate may be transmitted to the individual on a smartcard. The method concludes in a third computer process, on receipt of invalidity data indicative of invalidity of the certificate, by revoking the certificate by discarding the stored, private association.

In a related embodiment, transmitting the certificate includes transmitting using an encrypted communication link. The invalidity data may include an indication that a given length of time has elapsed since the light-weight certificate was transmitted to the individual. Or the invalidity data may include an indication that a person other than the individual has obtained unauthorized access to the light-weight certificate.

In another exemplary embodiment of the invention there is provided a method of determining whether to approve a potential transaction between an individual and a relying party. The method, carried out by a third party authentication service, includes in a first computer process, receiving data from the relying party, the data including a first cipher generated by a token facility; in a second computer process, applying the given mathematical function to a shared secret to produce a second cipher; and in a third computer process, determining that the transaction is not approved if the first cipher is not equal to the second cipher. The token facility is under control of the individual, and stores a light-weight certificate. The light-weight certificate has the shared secret, which is shared only by the token facility and the authentication service. The first cipher is a given mathematical function of the shared secret. Typically, this function is referenced in the certificate itself The light-weight certificate may be stored in a smartcard, and the smartcard produces the first cipher by applying the given mathematical function to the shared secret. In some embodiments, the smartcard is housed within an electronic device, and the individual causes the smartcard to produce the first cipher only after providing, to the electronic device, biometric information or a password. Rather than using a physical smartcard, the first cipher may be produced by a virtual smartcard under the control of the individual.

In some embodiments, the data received from the relying party include information pertaining to the transaction, such as a credit account number, a transaction amount, and a merchant identifier. In these embodiments, a further method includes, in a fourth computer process, debiting the transaction amount from the credit account and crediting the transaction amount to a merchant associated with the merchant identifier.

The given mathematical function may be a pseudo-random number generator and the shared secret may be a seed number for the pseudo-random number generator. Or, the shared secret includes an indexed list of ciphers, the data include a given index, and the given mathematical function comprises selecting the cipher in the list of ciphers having the given index. In this alternate embodiment, the index may be a sequence number that is strictly larger than any sequence number received by the authentication service in relation to a previous potential transaction to which the individual was a party.

In a further exemplary embodiment of the invention, there is provided a method for granting an electronic device access to a digital certificate stored in a hardware security module. This method includes, in a first computer process, transmitting an unlock request to an authentication service, the unlock request including a sequence number; in a second computer process, receiving from the authentication service a response containing a first cipher; and in a third computer process, providing the first cipher and the sequence number to the hardware security module. The first cipher is generated by applying a given mathematical function to both the sequence number and a secret shared only by the authentication service and the hardware security module. Furthermore, the method calls for the hardware security module applying the given mathematical function to the sequence number and the shared secret to produce a second cipher, and refusing to grant the electronic device access to the digital certificate if the first cipher and the second cipher are not identical. In related embodiments, the hardware security module grants the electronic device access to the digital certificate only after receiving biometric information or a password of the individual.

### BRIEF DESCRIPTION OF THE DRAWINGS

The foregoing features of the illustrated embodiments will be more readily understood by reference to the following detailed description, taken with reference to the accompanying drawings, in which:

FIG. 1 is a schematic diagram showing how data messages are passed between various components of a system in accordance with an embodiment of the invention;

FIGS. 2A and 2B show in greater detail the asymmetric nature of the inbound and outbound data paths in the message passing of FIG. 1;

FIG. 3 is a block diagram showing a method for distributing security information between the relevant components of the system of FIG. 1;

FIG. 4 is a schematic block diagram showing a process for managing the life cycle of a light-weight certificate in accordance with an exemplary embodiment of the invention;

FIG. 5A is a schematic block diagram showing the client-facing processes of an exemplary merchant transaction using the light-weight certificate; and

FIG. 5B is a schematic block diagram showing the server-facing processes of the exemplary merchant transaction of FIG. 5A.

### DETAILED DESCRIPTION OF SPECIFIC EMBODIMENTS

As used in this description and the accompanying claims, the following terms shall have the meanings indicated, unless the context otherwise requires:

A “digital certificate” means a public key certificate in accordance with a public key infrastructure, such as that defined by the International Telecommunication Union (ITU) standard X.509. Digital certificates are used to bind (associate) a public encryption key to an identity. Digital certificates may contain, for example, a serial number, an identity of a person or organization (called a “subject” by X.509), a public key associated with the identity, a signature algorithm, valid-from and valid-until dates, and a certificate issuing entity, among other data.

A “light-weight certificate” (LWC) means a digital certificate that lacks data that would associate the certificate with an individual, namely identity or X.509 “subject” data. A LWC cannot be used alone to bind a key to an identity, or to authenticate an individual. Furthermore, in a typical embodiment of this invention, a cryptographic key stored within a LWC may be used for purposes other than public key cryptography, as that phrase is known in the art.

“Privately associating” a certificate with an individual means associating the certificate with the individual by means that are external to the certificate, so that, following the association, only the individual and the entity that performed the association know that the certificate is associated with the individual. The certificate must lack data associating the individual with the certificate in order to effectuate such private knowledge. In particular, digital certificates that include X.509 “subject” data cannot be “privately associated” within the meaning of this phrase as used herein.

A “token facility” is an arrangement by which an individual may control use of a light-weight certificate that has been privately associated with the individual. In particular, a token facility may be a physical smartcard, or a “virtual” smartcard, in which a LWC is stored. A physical smartcard may store the LWC in a hardware security module, for example. A virtual smartcard may be implemented as a server-based arrangement, accessible over a network by the individual, that provides secure storage of the LWC. Regardless whether the token facility is implemented as a physical smartcard or a virtual smartcard, the token facility is configured to generate a cipher by applying a given mathematical function referenced in the LWC, to a key included in the LWC.

An organization, such as the Department of Defense or a corporation such as a bank, may have information that is secret, but that nevertheless must be distributed to employees, agents, or other individuals in insecure locations. The organization may require, due to operational concerns, that secret information be transmitted to or from its agents using unsecured data communications channels, such as the Internet. In order to implement this requirement, the organization may encrypt the data it sends to its agents, and establish encryption protocols that its agents must use on their devices to facilitate the encryption. However, the organization must necessarily provide access to its systems using the unsecured channels, so that its agents may contact it. This access allows unauthorized, and potentially malicious parties to attempt to gain access to the organization's systems. Thus, the organization may create a private database of clients that are authorized to receive information from its servers.

### System Description

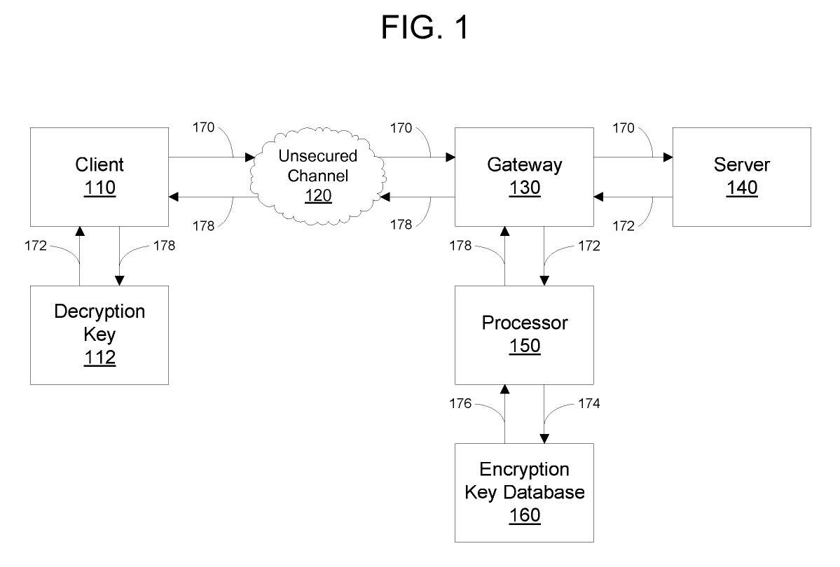

FIG. 1 is a schematic diagram showing how data messages are passed between various components of a system in accordance with an embodiment of the invention. An individual in control of client 110 wishes to retrieve information from server 140. Communications between the client 110 and the server 140 are sent through an unsecured communication channel 120, such as the Internet. The organization providing server 140 receives all incoming communications through gateway 130. The request for information is processed by server 140, and sent back to gateway 130. In accordance with the exemplary embodiment, all outbound communications from the server 140 to the client device 110 are intercepted by gateway 130 and sent to processor 150 for authorization processing. Processor 150 consults encryption key database 160, determines if the communication is authorized, and if so, provides an encrypted message to gateway 130. If the authorization succeeded, gateway 130 transmits the encrypted message to client device 110 using the unsecured communication channel 120. Client 110 then decrypts the encrypted message, using a decryption key 112 provided by the organization specifically for this purpose.

Client 110 may be any device or process that is able to perform encryption and decryption of data messages and communicate with other devices or processes using a data communication network. By way of example and not limitation, client 110 may be a process running on a personal computer, a smartphone, a personal digital assistant, or it may be a device specially constructed for use in connection with embodiments of the invention disclosed herein. Decryption key 112 may be stored in a computing device that is separate from client device 110, and permits client device 110 to access the decryption key 112 only indirectly so that the data of the decryption key never leave the storage device. The storage device may be a smartcard, for example, a United States Department of Defense (DoD) Common Access Card, or another Personal Identity Verification (PIV) device complying with Federal Information Processing Standards Publication 201 (FIPS-201). Decryption key 112 may be a symmetric key as known in the art of symmetric encryption, or the private key in a public-private key pair as known in the art of asymmetric encryption.

Unsecured communication channel 120 will commonly be the Internet, but may be any other unsecured communication channel such as a telephone, radio, or satellite communication channel whose signals are susceptible to interception by attackers. While the illustrated embodiments are adapted to provide security for data communication on an unsecured communication channel 120, these embodiments may also be used on secure channels, and the characterization of channel 120 as unsecured should not be read to limit the scope of the claimed invention.

Gateway 130 will typically be a data firewall or router, such as those commonly available for retail purchase from, among other vendors, Cisco Systems, Inc. of San Jose, Calif. If gateway 130 is a retail firewall, it must be capable of forwarding all communications that have a destination address reachable across the unsecured channel to processor 150. Gateway 130 alternatively may be a specialty device designed for use with embodiments of the present invention, or it may be a service running on a general purpose computer.

Server 140 may be any device or process that performs a useful service. Such services may include, for example, providing confidential or secret information to an individual having need of it. Server 140 may be a personal computer, workstation, mainframe, or any other computing device that provides a computing service, without limitation. For example, as described below in connection with a retail transaction, server 140 may include an authentication service, a credit service, and a funds transfer service provided by a credit issuer.

Processor 150 may be any device or process that performs data encryption and can retrieve information from a database of authorized clients. Typically, processor 150 is a process executing on a computer, but it may be a specialty hardware device constructed for use in accordance with embodiments of the invention. Encryption key database 160 is a database for storing digital records of encryption keys, as is known in the art or as specially designed, and may be implemented on the same computing device as processor 150, or on a different computing device. The encryption keys stored in database 160 may be symmetric keys as known in the art of symmetric encryption, or public keys that each form one half of a public-private key pair, as is known in the art of asymmetric encryption. Thus, each encryption key stored in database 160 is paired with a corresponding decryption key 112 securely stored by a client 110.

To maximize system security, encryption keys in encryption key database 160 should not be accessible from server 140, and should be exposed only to processor 150. Thus, even if the security of server 140 is compromised, there is no way for an attacker to gain access to the database of encryption keys and complete a man-in-the-middle attack. Nevertheless, the organization that exercises administrative control over server 140 may be the same organization that exercises common control over database 160 (for example, a corporate IT department). System security is maintained so long as there is no network path between server 140 and database 160 except through gateway 130. Gateway 130, in turn, does not permit certificates in database 160 to be modified, or even exposed. Thus, encryption keys in database 160 are inaccessible to server 140 through purely computer networking means.

In accordance with various embodiments of the invention, an individual who wishes to receive services from server 140 causes client 110 to transmit a client request message 170, requesting the services. Message 170 contains address information for server 140, that allows unsecured channel 120 to route it toward server 140. Message 170 passes through the unsecured data communications channel 120 and reaches gateway 130, as indicated. At this point, gateway 130 may perform pre-processing and filtering of message 170 according to methods known to persons having ordinary skill in the art. Such filtering may include, for example, discarding messages from known malicious individuals and discarding malformed messages.

After receiving the request message 170 and accepting it, gateway 130 forwards it to server 140. Server 140 processes the message 170, and generates a responsive message 172 according to the service requested. Response message 172 contains address information that allows unsecured channel 120 to route it toward client 110. Gateway 130 receives data message 172. However, whereas typical prior art systems would forward the data to the unsecured channel 120 without further processing, in accordance with the illustrated embodiment, gateway 130 instead transmits response message 172 to processor 150.

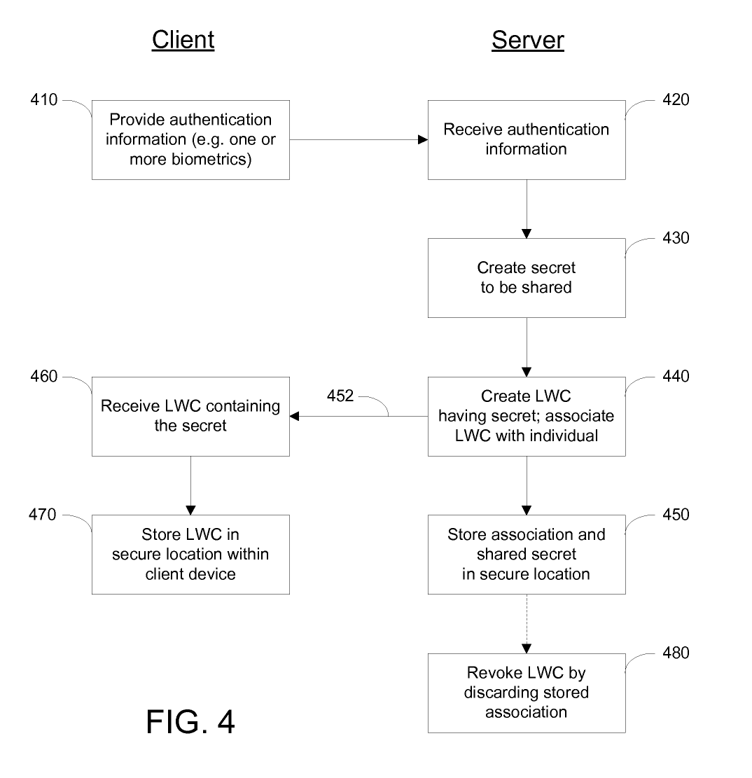

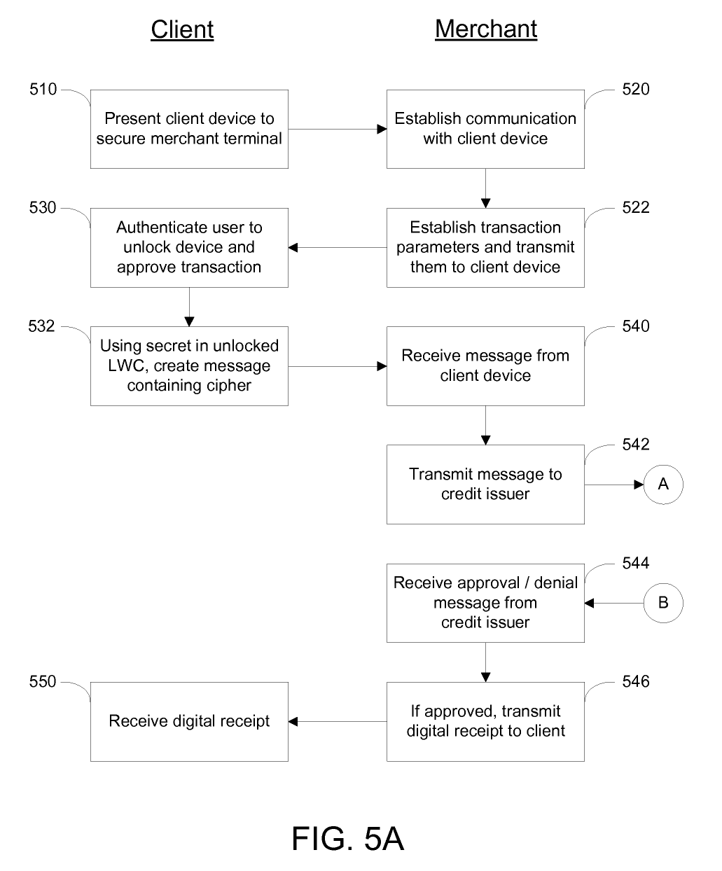

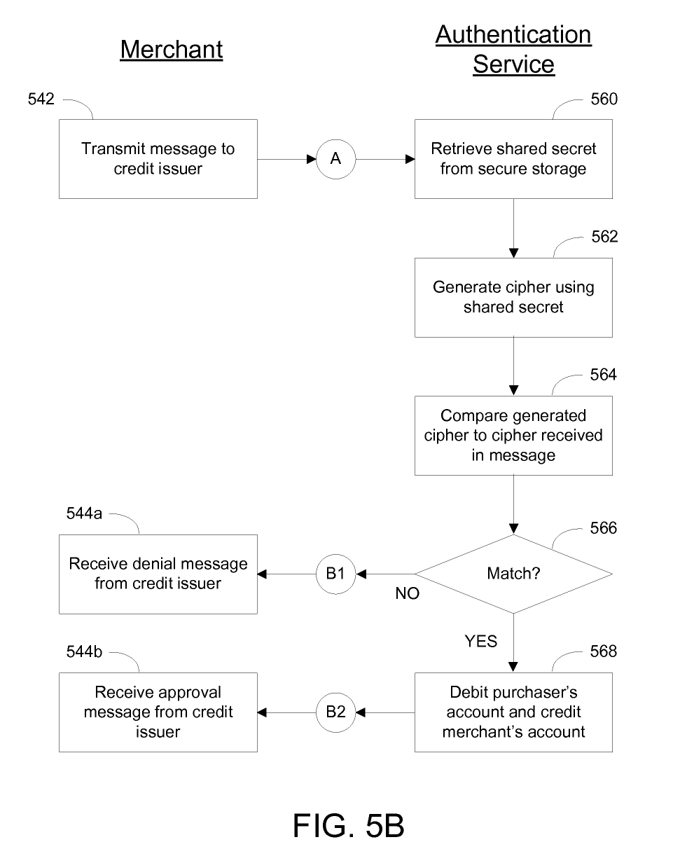

Processor 150 extracts the client address information or other uniquely client-specific data from message 172. Such other data may include data extracted from a light-weight certificate, sent by the client 110 to the server 140, for example. Light-weight certificates are discussed in connection with FIGS. 4 and 5 below. Using this data, processor 150 generates a database request message 174 and consults encryption key database 160 to determine whether database 160 contains a record of this data. Database 160 forms a query response message 176. If the database 160 does not contain an appropriate record, message 176 may indicate to the processor 150 that the client is unauthorized, or it may simply indicate that a record was not found and leave the processor 150 to determine whether the client is unauthorized. Processor 150 may then determine to not encrypt a reply for client 110, and may take any other appropriate security action, such as alerting an operator that an unauthorized access was attempted.

In accordance with the discussion of light-weight certificates below, it may be that database 160 does not contain an appropriate record because the certificate was revoked. In such cases, the processor 150 prevents the establishment of a secure communications channel between server 140 and client 110. Advantageously, the certificate may be revoked without exposing its data to the public (and permitting man-in-the-middle attacks). Also advantageously, the processor 150 is not under the control of server 140. Thus, no service executed by server 140 can cause a certificate to be added to, removed from, or modified in database 160. So, even if the security of server 140 is compromised, a secure communication channel will not be formed, unlike prior art systems.

If the database 160 does contain an appropriate record, message 176 will include, among other data, an encryption key that complements decryption key 112. This encryption key is used by processor 150 to encrypt server response message 172 using an encryption algorithm. Processor 150 generates an encrypted message 178 that is addressed to be routed to client 110 using the routing information from response message 172, and transmits it to gateway 130. Encrypted message 178 may only be decrypted by client device 110, due to properties of encryption algorithms known in the art. Gateway 130 receives the encrypted data message 178 from processor 150, and transmits it to client 110 using the unsecured data communications channel 120. Once client 110 receives the encrypted data message 178, it uses decryption key 112 to decrypt the message, thereby recovering the substance of server responsive message 172 as indicated by the numbering of the arrows.

It should be noted that, in the above process, the decision to route data is a property of the system separate from the actual contents of messages 170, 172, and 178. Server 140 is not connected to encryption key database 160 except through gateway 130. An organization may require that gateway 130 can be updated only by an operator with physical access at a secure facility. Thus, the organization controls the entire “management path” for the data, preventing an attacker from remotely installing its own encryption key in database 160. Even if a third party were able to somehow compromise server 140 blindly (i.e., without using information contained in the encrypted response messages 178), the third party would be unable to install a certificate in database 160 that would allow it to later decrypt messages 178. Thus, an attacker cannot get any useful information from the compromised server 140, despite the fact that the server is compromised. In fact, without the ability to decrypt messages 178 it would be difficult for an attacker to determine whether the compromise were successful at all. This situation provides advantages over the prior art, in which compromised systems provide clear indications to an attacker that they are, in fact, compromised.

It should also be noted that, with the exception of the processor 150 and the database 160, the components of the system described above may be already installed and operational at an organization's data center. This embodiment of the invention may be implemented by adding processor 150 and database 160 to an existing computer network, and configuring gateway 130 manually. Thus, the embodiment advantageously may be deployed by the organization with a minimum of operational expense and labor.

It may be the case that an attacker wishes to pose as the authorized individual. In such cases, client device 110 is not the actual client device of the authorized individual, but instead a client device that only purports to be the correct client device. In such a case, the unauthorized client device 110 makes a false assertion of identity in request message 172. However, as described above, the processor will request the encryption key of the authorized individual from encryption key database 160, and use this key to encrypt message 178. Thus, if an unauthorized client device 110 receives this message, it is unable to decrypt message 178 because it does not have possession of decryption key 112. Thus, it is impossible for a would-be attacker to decrypt the response message.

In the prior art, attackers have circumvented this restriction by attacking the encryption and decryption keys themselves. Prior art servers would obtain the public encryption key of a client device from a certificate authority (CA) in a public key infrastructure, typically by accessing the Internet. As the Internet is insecure, would-be attackers have successfully posed as the CA in addition to posing as the client 110. Thus, the attacker posing as the CA provides the server with a public key purportedly tied to a private key of the individual, that is in reality tied to a private key of the attacker. Thus, the server encrypts the response message using the attacker's public key, which the attacker then decrypts using the associated private key.

Various embodiments of the present invention advantageously completely eliminate the threat posed by the above scenario, by privately associating the encryption key with the individual. Such private associations are not accessible to any client device, especially that of a would-be attacker. Thus, it is impossible for an attacker to forge the encryption key that is used to create message 178. In some embodiments, the association and the encryption keys themselves are stored in a database 160 that is inaccessible even to server 140 using network data communications. Thus, even if the attacker compromised server 140, the attacker would not be able to forge encryption keys in database 160. Instead, the attacker would need physical access to encryption key database 160 to effect a man-in-the-middle attack against the encryption key, a very high security requirement.

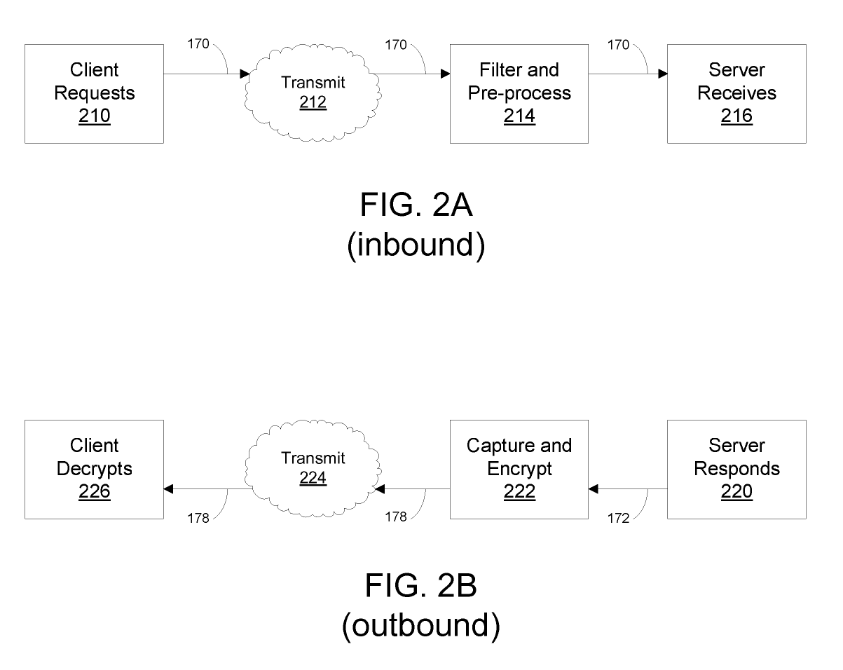

FIGS. 2A and 2B show in greater detail the asymmetric nature of the inbound and outbound data paths in the message passing of FIG. 1. In particular, FIG. 2A shows the inbound data path of a service request message 170. A client generates 210 a request message 170. The client then transmits 212 message 170 through the unsecured channel. The message 170 is received by the gateway, which performs preliminary error checking and filtering 214 as is known in the art. If the message passes the filter, it is passed along to the server, substantially undisturbed, where it is processed 216 and services are performed. It should be noted that in some embodiments, the gateway may act as a proxy for the server, and change some of the envelope of message 170. In particular, the gateway may change the destination address of the message 170 to be a local area network address of the server. However, such changes to the message envelope do not change the functionality of the embodiment, as described herein. As should be understood by a person having ordinary skill in the art, these and other manipulations of the data that do not alter the content or purpose of the message 170 may be made without deviating from the scope of the invention.

FIG. 2B shows the outbound data path of a service response message 172. As can be readily seen, the outbound data path is different from the inbound data path. After the server request has been processed 216, the server responds 220 to the requested service by generating a response message 172 for return transmission to the client. The server sends message 172 toward the client, where it passes through the gateway, as described above. However, unlike the data path for inbound traffic, the gateway captures message 172, and forwards it to the processor 150 for encryption, as indicated by box 222. This contrasts with the filtering and pre-processing in box 214, which leaves the content, or “payload,” of the inbound message 170 substantially unchanged. Rather, outbound message 172 is processed to be encrypted in box 222, to form a message 178 having different, encrypted content. Once the processor 150 forms message 178 and returns it to the gateway, the gateway transmits 224 the message to the client, where it may only be decrypted 226 by an authorized individual possessing the appropriate private decryption key.

One notable feature of the outbound data path is that the message 178 that gateway 130 delivers to the unsecured data channel 120 is different from the server response message 172. In particular, processor 150 has encrypted message 172 to form message 178 according to an encryption algorithm. The algorithm has used the encryption key corresponding to decryption key 112, which processor 150 has retrieved from encryption key database 160. The organization providing the service can guarantee that the encryption key is not known outside of database 160, housed at a secure location and inaccessible via the normal data path. The organization can also guarantee, through appropriate security measures such as biometric authentication, that the decryption key is not accessible to anyone other than the authorized individual wishing to obtain services. In this way, the organization can provide secure, end-to-end data encryption of the service response messages provided by server 140.

Another notable feature of the outbound data path is that server 140 may address all of its responses to client 110 using ordinary methods known in the art such as the Internet Protocol, without having any knowledge of processor 150 or encryption key database 160. Thus, processor 150 and database 160 may be added transparently to an existing system without disturbing server operations. Gateway 130 must be modified to forward all outbound traffic to processor 150 and forward traffic from processor 150 to the unsecured channel, but this change can be made with minimal operational impact.

Another notable feature of the outbound data path is that the outbound data message 178 has a layer of encryption that is not present in either request message 170 or response message 172. Client request message 170 may be sent without encryption, or its contents may be encrypted, for example by SSL. Similarly, server response message 172 may use the same level of encryption (none or SSL) used by the client request message 170. However, processor 150 adds a further layer of encryption to message 178, so that the “payload” of message 178 has an extra layer of encryption that must be decrypted by the client.

In one embodiment, the server response message 172 is SSL encrypted. The encrypted payload of this message is further encrypted to form message 178. In this embodiment, the client must first decrypt message 178 using the decryption algorithm, then decrypt the payload using SSL decryption. This embodiment requires modification to the encryption stack, and in particular requires modified SSL encryption software or hardware to function properly.

In an alternate embodiment, gateway 130 acts as a proxy for server 140, and client 110 performs point-to-point SSL encryption directly with gateway 130. In this embodiment, client request message 170 is decrypted before it reaches server 140, so server response message 172 may be unencrypted. Thus, gateway 130 encrypts message 172 to form encrypted message 178, which becomes the payload that the gateway encrypts using the SSL protocol. In this embodiment, client 110 may perform standard SSL. When client 110 decrypts the message according to the SSL protocol, the resulting SSL-decrypted message will still be encrypted using the additional layer of encryption. The client then proceeds to decrypt the payload using decryption key 112 to recover the original response message 172.

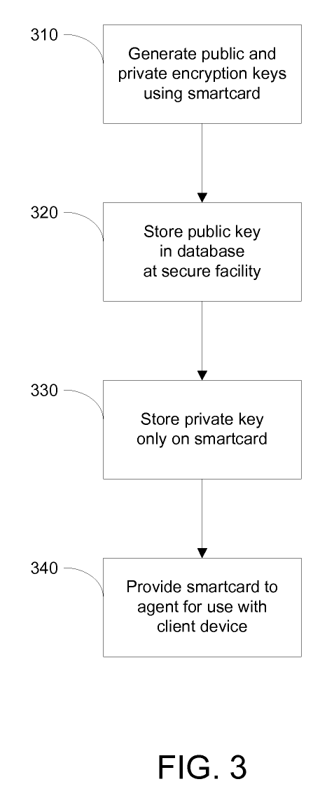

To ensure that only its authorized agents are able to access its systems, the organization may create a list of authorized users. FIG. 3 is a block diagram showing a method for distributing this security information between the relevant components of the system of FIG. 1. In accordance with embodiments of the present invention, the organization issues authorized individuals a security device, such as a smartcard, containing encryption information including decryption key 112. In step 310 an authorized individual generates encryption and decryption keys using the smartcard, typically under the supervision of the organization. In step 320, the organization stores the encryption key in a database at a secure facility. The database may be located at the same secure facility at which step 310 occurs, or the organization may transfer the encryption key by a secure data channel to a database at another secure facility. In step 330, the decryption key is stored only on the smartcard. Typically, this step happens automatically, so that only the smartcard hardware has direct access to the decryption key throughout the generation process. In step 340, the organization provides the smartcard with the decryption key to the authorized individual or agent. At a later time, when the agent wishes to contact server 140, the agent can connect the smartcard to a networked computing device and follow the procedure shown in FIG. 1. The organization may require the agent to provide a biometric, such as a fingerprint, as an additional test that must be passed to access the decryption key. Information from this biometric may be programmed into a secondary device, such as a smartphone.

An authorized individual then connects the security device to client 110 before making a secure transaction with server 140. Client 110, which may be a previously programmed smartphone, requires the authorized individual to provide evidence of the individual's authorization to use the security device, such as the biometric required by the organization. Once the individual has been authorized to use the security device, client 110 is granted access to the decryption key stored within using methods known in the art, and the procedure shown in FIG. 1 may commence.

The systems and methods described herein may be applied in novel ways to solve problems for which there has been a long-felt need in the art. Several such problems are described below. In these descriptions, server 140 may act as a security clearinghouse that enables client 110 to interact with other servers, not shown. One model for this type of system may be found in the Windows Live™ network of Internet services, provided by Microsoft Corporation of Redmond, Wash.

A first problem that embodiments of this invention may be used to address is that of enforcing an authorized individual's different levels of access to different computer systems. For example, an individual may be authorized to make a certain number of service requests in a given time period, or to receive a certain amount of bandwidth from a service provider, or to engage in limited types of service transactions. By associating a unique encryption key with each individual request, these policies can be changed and enforced by the system without further intervention from the authorized individual.

A second problem that may be addressed is that of single-login access to system services. Multiple logins may be prevented because all successful transactions with server 140 require that client 110 is able to correctly receive and decrypt messages sent by server 140, and correct decryption requires access to the encryption key securely provided by the organization, which the organization can guarantee is unique. Thus, consider the situation in which a first request is received by gateway 130 and a first response using a corresponding encryption key is encrypted by processor 150. When a second request is received, processor 150 can determine, based on the client addressing information in message 172, whether this message originated from a second address but used the same encryption key. If so, processor 150 has detected a multiple sign-on event, and may take an appropriate security action, such as alerting a system operator or invalidating the key.

Single-login access may be used to enforce a “single sign-on” system, wherein a single token may be used to provide different levels of authorization to a number of different services. In such a system, each different service may expect to see an authorization token that permits an individual various levels of access to the service. In accordance with various embodiments of the invention, server 140 may provide such a token in response to a request by client 110. The token may be opaque to the individual, and it may be specific to a particular service. Client 110 may then present the token to the service. Each service may trust that the token is unique, because of the single-login feature described above—the server 140 only issues one token at a time for a given (individual, service) pair.

A third problem that may be addressed is that of logging and monitoring activity. Because all secure transactions requested by an authorized individual have to pass through processor 150, all server responses addressed to that individual may be monitored. If a user attempts to exceed their authorization, processor 150 may decline further requests to encrypt data addressed to the individual, thereby terminating communications.

One way in which the data may be monitored is through the use of a “buddy” system. In a buddy system, events and actions are transmitted to the requesting client 110 and to a second, buddy system (encrypted using the buddy system's encryption key). The events may be key events of a particular type, such as login attempts, or they may be selected at random or with a given frequency from the collection of all inbound or outbound messages. The second, buddy device may be operated by an individual tasked with monitoring transactions for suspected fraudulent or malicious activity. Such a system provides an additional level of security, by allowing authorized individuals to review the account activity of others in real time.

### Use in Secure Transactions

The secure, two-way communication channel described above may be used advantageously in connection with secure transactions. For example, an individual may wish to purchase a good or service using a credit card. In the prior art, the individual will typically provide a merchant with a plastic credit card bearing an account number, both embossed onto the body of the card and present on a magnetic stripe on the card's reverse. The merchant swipes the card through a magnetic stripe reader, which reads the account number into a computer. The merchant enters a sale amount, and the transaction is authorized or denied. If the sale is authorized, the merchant formalizes the sales contract by requiring the individual to sign a receipt showing that the goods or services were provided. If desired, the merchant may compare the signature with a signature on the reverse of the card to prove the individual's identity.

However, credit cards can be forged, and signatures of other people may be practiced until their execution is natural. Merchants who rely on this transactional system generally have only the presence of the physical card and the signature of the individual to authenticate the identity of the individual. Authorization to proceed with the sale is obtained based on this incomplete and easily forged information.

A much improved system using light-weight certificates is now described. In the course of authorizing a transaction, the light-weight certificate (LWC) forms one piece of a two-factor identity authentication process, while the other piece is provided by the credit issuer. In this way, the signing individual is simultaneously authenticated and authorized to make the purchase. At the same time, the credit issuer obtains a much stronger guarantee that the authenticating individual is who he or she claims to be. Thus, it is anticipated that rates of consumer fraud and credit charge backs will be greatly reduced for credit issuers and merchants who take advantage of embodiments of the present invention. Also, while illustrative embodiments are given in the context of a sales transaction, the embodiments may be used in any situation in which an individual must authenticate his identity to a service provider, and the invention is not limited to just the illustrative embodiments.

The two-factor authentication process works generally as follows. A secret number is generated, for example by a security office of an organization. A LWC is created to hold this secret, and is installed in a device in such a manner that only a given individual may access it. For example, the LWC may be installed in a smartcard that requires biometric data to be input before it may be used, and the smartcard installed in the individual's smartphone. However, the LWC by itself contains no information tying the individual to an assertion of identity. The secret is also stored by the security office. When a transaction is proposed by the individual, a transaction identifier is created, and a mathematical function is applied to the secret and the transaction identifier both by the smartcard and the organization to create two ciphers. If these two ciphers match, then the individual is authenticated, and may log into a computer system, enter a purchase transaction, or engage in any other activity restricted to properly-authenticated individuals. These processes are now described in greater detail in FIGS. 4 and 5.

FIG. 4 is a schematic block diagram showing a process for managing the life cycle of a light-weight certificate in accordance with an exemplary embodiment of the invention. In process 410 an individual provides authentication information that uniquely identifies the individual to a client device, such as client device 110. For example, the individual may provide a biometric such as a fingerprint, or provide a password. In process 420 an authentication service having a server, such as server 140, receives this information from the individual. Any technique known in the art may be used to receive the information—typically, a secure data communication link is used. In process 430 the server creates a secret to be shared with the individual. Some embodiments of the invention described herein use a large number as a seed to a pseudo-random number generator, while others use a list of random ciphers (e.g. a one-time pad), although it will be understood that any appropriate shared secret may be used.

In process 440 the server creates a light-weight certificate (LWC) containing the shared secret. The LWC may be digitally signed by the server using the server's public key for added security, but a digital signature is not required. The certificate does not contain any information that a third party may rely upon to securely identify the individual. But, because it created the LWC for the individual, the server has unique knowledge of the association between the LWC and the individual. In process 450, the server stores data representing this association, and the shared secret, in a secure location accessible only to the authentication service. As noted before, the server need not store these data locally, but may store them in a storage network so that other servers may have access to them. For example, the data may be stored in a shared database as a database record, although other embodiments may be used.

The server then transmits the certificate to the individual, as shown by arrow 452. Transmitting a certificate to an individual may be accomplished by a variety of methods, including physically delivering to the individual a digital storage medium containing the certificate. For example, the individual may be given a smartcard containing the digital certificate in non-volatile storage, or a smartphone in which is installed such a smartcard. In other embodiments, the LWC is sent to the client device over a secure, encrypted data communication link, such as that described above in connection with FIGS. 1 and 2. In process 460, the client device receives the certificate. Only the server and the client device possess any information connecting the individual to the LWC, including the shared secret. In process 470, the client device stores the certificate in a token facility (assuming the individual did not receive the certificate already in secure storage). For example, the client device may contain a token facility, such as a smartcard. Access to the smartcard may be protected using the same authentication information that the individual originally provided to the server. In this way, an LWC containing information associated with an individual may be accessed only by the individual.

In order to use an LWC in a transaction, as described more fully below in connection with FIG. 5, the client device uses the shared secret in the certificate to create a message that must be authenticated by the server. Thus, the server may effectively revoke the certificate by simply discarding the association between the individual and the shared secret, as shown in process 480. This may be as simple as deleting an entry in a database upon receipt of data indicating that the certificate is invalid. All further requests to authenticate the individual will fail, as the server no longer associates a shared secret with a requesting individual. At the same time, the certificate also may be deleted.

There may be many reasons why a light-weight certificate should be revoked. For example, certificates may be issued for only a given length of time. This time may be as short as minutes, to force the individual to complete a transaction in the immediate future. Or, the time may be one year, to force the individual to contact the certificate issuer on a regular basis. Any amount of time may be used, depending on the intended purpose of the issued LWC. Alternatively, a certificate may be revoked because a person other than the authorized individual has obtained unauthorized access to the LWC. Thus, if a person has authenticated herself to her smartphone that contains the LWC, and the phone is stolen, the person may quickly call the certificate issuer and report that her phone was stolen. The issuer may immediately delete the association between the individual and the LWC from the association database, thereby preventing unauthorized use of the certificate. Other reasons for expiring certificates are known in the art, and skilled persons may think of other reasons not disclosed herein that do are within the scope of the invention.

For the given individual to re-establish the ability to authenticate, the processes shown in FIG. 4 may be repeated. However, in accordance with some embodiments of the invention, the server may retain the individual's authentication information, and use this information to resume the method of FIG. 4 at process 430. Thus, in these embodiments, the individual need only provide the authentication information to the issuing server once to establish the individual's identity to the server, enhancing the security of the overall system.

A light-weight certificate created and managed according to this method may be used to securely transact business, as shown in FIGS. 5A and 5B. In these Figures an individual possessing a client device wishes to enter a commercial transaction. For example, the individual may wish to purchase goods or services from the merchant using a credit card. From the individual's perspective, he presents a client device, such as a smartphone, to a secure merchant (point of sale) terminal The client device then requests that he provide a password or biometric information, such as a fingerprint, to verify the transaction. A few seconds later, he receives a digital receipt indicating that the transaction has been completed. A smartphone that may be used in such a procedure is disclosed in U.S. patent application Ser. No. 12/267,065.

The merchant, on the other hand, must verify the identity of the individual to prevent credit card fraud that might result in a costly charge-back. For this reason, the merchant is also called the “relying party” in the transaction, because he or she must rely on the individual's proof of identity. To verify the individual's identity, the merchant requests that the client device create an encrypted message that only that particular individual and device can generate. The merchant then verifies the identity of the individual by sending the message to a trusted authentication service (e.g., the server of FIG. 4, which in this case may be operated by the purchaser's credit issuer or bank). In order for the client device to create such an encrypted message, the encryption key must be unlocked by the individual providing a biometric or password, as described above. For added security, the merchant may require that this be done in his or her presence. The message that the merchant receives from the client device may be encrypted in such a way that the merchant (or importantly, a third party attacker) cannot see the meaningful contents of the message. For example, the message may be encrypted by the client device using a public encryption key of the authentication service, which the client device may obtain and validate using methods known in the art.

FIG. 5A is a schematic block diagram showing the client-facing processes of an exemplary merchant transaction using the matched pair of encryption keys. In process 510, the individual presents a client device to a secure merchant terminal. To provide a concrete example, the client device may be a smartphone carrying a smartcard or other token facility, although other electronic devices may be used in accordance with embodiments of the invention. In process 520, the merchant terminal establishes secure two-way data communication with the client device. Communication may be by way of Bluetooth, near-field communication, cellular communication, physical contact, radio-frequency communication, or a wired connection (for example). During this process, the merchant terminal may request the identity or contact information of the credit issuer—it is not necessary for the merchant to request the individual's credit card number or bank account number. In process 522, the merchant device establishes transaction parameters, such as a cost and a stock keeping unit (SKU) of an item or service for sale. The merchant terminal transmits this transaction-specific information to the client device using the secure local link.

In process 530, the client device receives this message, and requires the individual to provide information unique to the individual, such as a password or biometric information in order to confirm the transaction. For example, a message box may appear on the individual's smartphone, asking whether to proceed and providing YES and NO choices. If the individual is not already logged into the phone, the phone must first be unlocked using information unique to the individual. In this way, the system guarantees that only the correct individual (that is, the one who is able to unlock the phone) may generate a proper cipher.

In process 532, once the individual has entered this information and agreed to the transaction, the shared secret is unlocked. For example, a smartphone may have a smartcard or other token facility that can only be unlocked by receiving fingerprint data or a PIN. In some embodiments, the information used to unlock the phone (such as the PIN) also unlocks the smartcard. In other embodiments, the smartcard may itself be embedded in a plastic credit card or other similar vehicle, rather than a smartphone. In these embodiments, the individual inserts the card into a point-of-sale device, and then provides a PIN or a fingerprint to the device to unlock the smartcard. Any information that is unique to the individual may be used to unlock the smartcard. Once the smartcard is unlocked, the LWC contained within, and hence the shared secret, may be accessed.

Once the shared secret is unlocked, the token facility applies a mathematical function to the shared secret in order to create a transaction cipher. Typically, this function will use a transaction sequence number, that counts how many transactions have used this shared secret. For example, if the shared secret is a seed for a pseudo-random number generator (PRNG), then process 532 repeatedly applies the PRNG algorithm a given number of times to the seed according to the sequence number to produce a pseudo-random number that serves as the transaction cipher. (Alternatively, to save time, the last generated number may be stored in the smartcard, and the PRNG algorithm is applied once to the stored number while the sequence number is incremented.)

For additional security, the shared secret may be a list of transaction ciphers, such as a one-time pad. A one-time pad may be created by repeatedly executing a PRNG, by sampling a non-deterministic physical noise source, or by any other method. In embodiments that use a one-time pad, process 532 indexes the list according to the sequence number to select the cipher. Other methods may be used in this manner without departing from the scope of the invention disclosed herein. For even more added security, the sequence number may be non-sequentially increased. As long as the sequence number increases monotonically, then both the client device and the server may save storage space by discarding data pertaining to previously used sequence numbers.

To complete process 532, the client device creates a message containing the cipher generated by the token facility and the sequence number, if any, and transmits the message to the merchant. The message may include any other information sufficient to allow the authentication server to recreate the cipher. The message may also include the individual's credit account number, a bank (checking) account number, or other financial information. If desired, this message may be encrypted according to methods known in the art, including public key cryptography, but such encryption is not necessary. As noted above, such encryption prevents third parties (including the relying party) from obtaining this information.

The merchant terminal receives the message in process 540. In process 542, the merchant forwards the message to the authentication service as a transaction request, along with data identifying the merchant to the authentication service. Typically, a credit issuer or bank provides the authentication server, and the data is a merchant account number, although other indicia such as a merchant tax number may be used. After a process such as that shown in FIG. 5B, described more fully below, the merchant receives a reply in process 544. This request-reply message pair may be sent according to any number of secure methods, such as those described above in connection with FIGS. 1-3, or using public key cryptography. If the methods of FIGS. 1-3 are used, and the reply message is encrypted, then only the merchant is able to decrypt the reply message, advantageously adding security against third party attacks on the data path between the merchant and the authentication server. If the outcome is successful then the transaction has been processed, and money or credit has been transferred from the purchaser's account to the merchant's account. The merchant may send a digital receipt or other confirmation of the transaction to the purchaser in process 546. This is received by the client device in process 550.

Embodiments of the invention may be used to allow an individual to perform a transaction on credit, without having a client device in hand. In process 522 of such an embodiment, the merchant requires that the individual provide some data tied to their account number, for example a telephone number, a billing address, and biometric data. The server sends this information to a trusted third party, with whom the individual has previously established a token facility, such as virtual smartcard as disclosed in U.S. patent application Ser. No. 12/267,065. As before, the merchant may provide this information to the third party in an encrypted message and receive an encrypted response in accordance with methods described above in connection with FIGS. 1-3, or by using a public key infrastructure. Provided that the individual has entrusted the LWC to this third party (for example, in process 470), the third party may authenticate the individual using this data. If the individual is authenticated, the third party uses the virtual smartcard token facility to perform the functions required to generate the cipher ordinarily sent by the client device in process 532. In this alternate embodiment, however, the cipher is returned to the merchant in process 540 not by the client device, but by the third party. As before, the message having the cipher may be encrypted (by the third party) to prevent others from accessing its useful contents. Once the merchant has received the cipher, the process of FIG. 5A continues normally with process 542. In this embodiment, the merchant may provide a digital receipt to the trusted third party in process 546, as the individual does not possess a client device on which to store such a receipt.

FIG. 5B is a schematic block diagram showing the server-facing processes of the exemplary merchant transaction of FIG. 5A. Processes 542 and 544 are shown, as in FIG. 5A. As before, the merchant transmits a message to the authentication service (credit issuer) in process 542. Recall that the message contains a cipher (and sequence number), a purchase amount, a credit account number, and merchant identification data (e.g. a merchant account number). In process 560 the credit issuer retrieves the shared secret associated with the purchaser from a secure storage arrangement. For example, the credit issuer uses the purchaser's account number to locate the shared secret in a database established during the processes of FIG. 4, the database being accessible only to the credit issuer. Once the shared secret has been retrieved, in process 562 the credit issuer generates a cipher using the shared secret and the received sequence number, according to the method associated with that individual's LWC. For example, the credit issuer may only issue certificates that use pseudo-random number generators, in which case the credit issuer generates the cipher using the PRNG described in the LWC.

In process 564, the credit issuer compares the cipher it generated in process 562 with the cipher that the merchant transmitted in process 542. If these match, then the credit issuer may have a high degree of certainty that the cipher originated from the holder of the LWC. If the ciphers do not match, then the credit issuer may undertake fraud prevention steps, such as placing a fraud alert on the credit account. As shown in decision 566, if there is no match, the merchant receives a denial message from the credit issuer in process 544a. If there is a match, in process 568 the credit issuer debits the purchaser's numbered account and credits the merchant's numbered account using the purchase amount transmitted by the merchant. Finally, in process 544b the merchant receives an approval message from the credit issuer.

Embodiments according to FIGS. 5A and 5B are secure, in part, because a credit card number is no longer valid by itself to authorize a transfer of funds from the card holder without the validating cryptography. Even if the credit account number is transmitted in the clear (in process 532), it cannot be used to complete a transaction without the server's successful LWC challenge. Further, because each transaction is associated with a transaction ID received from the client device at the time of sale, it is very difficult for a malicious merchant to place a false debit request, even if the merchant possesses the credit card number. All communications between the server and either the user or the merchant may use strong security, such as that disclosed above in connection with FIGS. 1-3, which ensures that only the intended receiver can read messages intended for them. All messages in the system also may be digitally signed by the sending party, adding another layer to the overall security. Yet all of these processes are automatic and transparent to the individual and the relying party, allowing for ease of use.

Using light-weight certificates as described herein, certificate revocations are handled by a card issuer and never need to be published. Therefore the computational load required to implement the system scales linearly in the number of certificates. Embodiments of the invention provide all of the safety that PKI provides, in an environment that is light-weight and protects all parties. The set-up is advantageously minimal-cost. Light-weight certificates may have very long life spans (for example, 20 years or longer), avoiding the expense of re-issuing expired certificates. Furthermore, the client device may be a cell phone, which is the most common electronic device in the world.

In accordance with another embodiment of the invention, an individual may ‘unlock’ a certificate for use in an area having limited network connectivity. Doing so may be advantageous, for example, for a first responder entering a disaster area or potential crime scene. In this embodiment, the first responder essentially uses the processes of FIGS. 5A and 5B to unlock a certificate already stored on her client device.

To be more precise, a first responder transmits a message to the authentication service, which in this case is typically her parent organization (e.g. a police department or hospital). The authentication service generates a cipher and a sequence number (using the same techniques employed in process 532), forming the first part of the two-party authentication data. The service then transmits this cipher and sequence number to the first responder's client device. These data are provided to a token facility on the client device, such as a smartcard having a hardware security module (HSM). This HSM contains the LWC and the shared secret. The HSM performs the processes 560-566 using the shared secret. If there is a cipher match, then the HSM provides client device applications with access to the certificate. The LWC may then be used according to the rules provided in the certificate (e.g. valid-from and valid-until times, single use only, and so on). The LWC may be digitally signed by the parent organization, so the authenticity of the LWC may be determined directly by any device storing the organization's root certificate, even in an area with limited network connectivity. As before, the client device may be protected by password or biometric, providing added security in case the first responder loses the device. Additionally, because access to the HSM can only be obtained after performing the steps above, which authenticate the individual's identity, in these embodiments of the invention, the certificate need not be light-weight. In certain types of closed environments, it may be acceptable for a relying party to trust that the identity data in a full digital certificate is authentic, provided that access to the digital certificate is controlled in the manner just described.

The present invention may be embodied in many different forms, including, but not limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL). Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device.

The present invention may be embodied in other specific forms without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive. Numerous variations and modifications will be apparent to those skilled in the art. All such variations and modifications are intended to be within the scope of the present invention as defined in the appended claims.

What is claimed is:

1. A system for facilitating secure data communication from a server to a client device of an individual using a data communications channel, the system comprising:
a database that stores a plurality of encryption keys in a storage arrangement, wherein at least one stored encryption key is uniquely and privately associated with the individual;
a processor, in data communication with the database, configured
(i) to receive a message, created by the server in response to a request by a client device purporting to be that of the individual,
(ii) to retrieve from the database the encryption key that is uniquely and privately associated with the individual, and
(iii) to encrypt the message using the retrieved encryption key to form an encrypted message that only the client device of the individual is capable of decrypting; and
a communications gateway, in data communication with the data communications channel, the processor, and the server, the gateway configured
(i) to transmit, to the server, messages that are received from the data communications channel for delivery to the server,
(ii) to transmit, to the processor, the message created by the server in response to the request by the client device purporting to be that of the individual, and
(iii) to transmit the encrypted message to the data communications channel for delivery to the client device purporting to be that of the individual.

2. The system of claim 1, wherein the client device purporting to be that of the individual is the client device of the individual, and is therefore capable of decrypting the encrypted message.

3. The system of claim 1, wherein the client device purporting to be that of the individual is not the client device of the individual, and is therefore incapable of decrypting the encrypted message.

4. The system of claim 1, wherein the encryption keys are exposed only to the processor.

5. A method of facilitating secure data communication from a server to a client of an individual over a data communications channel, the method comprising:
receiving a message, created by the server in response to a request by a client device purporting to be that of the individual;
encrypting the message to form an encrypted message that only the client device of the individual is capable of decrypting, wherein encrypting provides to the contents of the response message a layer of encryption in addition to any layer of encryption present in the request by the client device purporting to be that of the individual; and
transmitting the encrypted message to the data communications channel for delivery to the client device purporting to be that of the individual.

6. The method of claim 5, wherein the client device purporting to be that of the individual is the client device of the individual, and is therefore capable of decrypting the encrypted message.

7. The method of claim 5, wherein the client device purporting to be that of the individual is not the client device of the individual, and is therefore incapable of decrypting the encrypted message.

8. The method of claim 5, wherein encrypting the contents of the response message includes retrieving the encryption key from a database of encryption keys, wherein the encryption key is not exposed to the server or to the client device purporting to be that of the individual.

9. A method of efficiently managing, by an authentication service, a certificate life cycle in the course of authentication of an individual, the method comprising:
in a first computer process, creating a secret number;
in a second computer process,
(i) creating a light-weight certificate, such certificate containing the secret number but lacking data associating the certificate with the individual,
(ii) privately associating the light-weight certificate with the individual, and
(iii) storing such private association in a non-volatile storage arrangement accessible only to the authentication service;
transmitting the light-weight certificate to the individual, so that only the individual and the authentication service possess the secret number; and
in a third computer process, on receipt of invalidity data indicative of invalidity of the certificate, revoking the certificate by discarding the stored, private association.

10. The method of claim 9, wherein transmitting the certificate includes transmitting using an encrypted communication link.

11. The method of claim 9, wherein the invalidity data are received because a given length of time has elapsed since the light-weight certificate was transmitted to the individual.

12. The method of claim 9, wherein the invalidity data are received because a person other than the individual has obtained unauthorized access to the light-weight certificate.

13. A method of determining, by an authentication service, whether to approve a potential transaction between an individual and a relying party, the method comprising:
in a first computer process, receiving data from the relying party, the data including a first cipher generated by a token facility that is under control of the individual, wherein a light-weight certificate is stored in the token facility, the light-weight certificate including a secret shared only by the token facility and the authentication service, the first cipher being a given mathematical function of the shared secret;
in a second computer process, retrieving the shared secret from a local storage arrangement and applying the given mathematical function to the shared secret to produce a second cipher; and
in a third computer process, determining that the potential transaction is not approved if the first cipher is not equal to the second cipher.

14. The method of claim 13, wherein the light-weight certificate is stored in a smartcard, and wherein the smartcard produces the first cipher by applying the given mathematical function to the shared secret.

15. The method of claim 14, wherein the smartcard is housed within an electronic device, and wherein the individual may cause the smartcard to produce the first cipher only after providing, to the electronic device, biometric information of the individual.

16. The method of claim 14, wherein the smartcard is housed within an electronic device, and wherein the individual may cause the smartcard to produce the first cipher only after providing, to the electronic device, a password of the individual.

17. The method of claim 13, wherein the first cipher is produced by a virtual smartcard under control of the individual.

18. The method of claim 13, wherein the data include a credit account number, a transaction amount, and a merchant identifier, the method further comprising:
in a fourth computer process, debiting the transaction amount from a credit account associated with the credit account number and crediting the transaction amount to a merchant account associated with the merchant identifier.

19. The method of claim 13, wherein the given mathematical function comprises a pseudo-random number generator and the shared secret comprises a seed number for the pseudo-random number generator.

20. The method of claim 13, wherein the shared secret comprises an indexed list of ciphers, the data include a given index, and the given mathematical function comprises selecting the cipher having the given index in the list of ciphers.

21. The method of claim 20, wherein the index is a sequence number that is strictly larger than any sequence number received by the authentication service in relation to a previous potential transaction to which the individual was a party.

22. A method for granting an electronic device access to a digital certificate stored in a hardware security module, the method comprising:
in a first computer process, transmitting an unlock request to an authentication service, the unlock request including a sequence number;
in a second computer process, receiving from the authentication service a response containing a first cipher generated by applying a given mathematical function to both the sequence number and a secret shared only by the authentication service and the hardware security module; and
in a third computer process, providing the first cipher and the sequence number to the hardware security module, the hardware security module
(i) applying the given mathematical function to the sequence number and the shared secret to produce a second cipher, and
(ii) refusing to grant the electronic device access to the digital certificate if the first cipher and the second cipher are not identical.

23. The method of claim 22, wherein the hardware security module grants the electronic device access to the digital certificate only after receiving biometric information of the individual.

24. The method of claim 22, wherein the hardware security module grants the electronic device access to the digital certificate only after receiving a password of the individual.

25. A communications gateway for facilitating secure data communication between a client and a server over a data communications channel, the gateway comprising:
a first data path for receiving a client request message from the client and forwarding the client request message to the server;
a second data path having an input for receiving a response message from the server, the response message being responsive to the client request message;
a processor, coupled to the second data path, for encrypting the contents of the response message using an encryption key to form an encrypted message, the encryption key being uniquely and privately associated with a decryption key stored for use by the client, so as to provide to the contents of the response message a layer of encryption in addition to any layer of encryption present in the client request message;
wherein the second data path includes an output for transmitting the encrypted message to the client over the data communications channel.

26. The gateway of claim 25, further comprising a storage system, coupled to the processor, containing a database of encryption keys, such storage system being accessible using network data communications only to the processor.

27. The gateway of claim 26, wherein the storage system and the server are coupled to an administrative control system for exercise of common control over the database of encryption keys and the server.
